(19) United States
(12) Patent Application Publication
(10) Pub. No.: US 2007/0297411 A1
(43) Pub. Date: Dec. 27, 2007

(54) Method and Device for Generic Framing Procedure Encapsulation

(75) Inventor: Laijun Zhong, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/745,281

(22) Filed: May 7, 2007

(30) Foreign Application Priority Data
Jun. 23, 2006 (CN) 200610090137.6

(51) Int. Cl. H04L 12/56

(52) U.S. Cl. 370/392

(57) ABSTRACT

A method for Generic Framing Procedure (GFP) encapsulation includes: cascading a plurality of protocol data units to form a cascaded packet; and encapsulating the cascaded packet to obtain a GFP frame. A device for GFP encapsulation includes a cascading module, for cascading a plurality of protocol data units to form a cascade packet, and a GFP encapsulation module, for encapsulating the cascade packet to obtain a GFP frame. According to the method and the device, the occupation rate of the payload in a single GFP frame is increased and thus transmission efficiency is improved.

### CROSS-REFERENCE TO RELATED APPLICATION

The priority benefit of Chinese Patent Application No. 200610090137.6, filed Jun. 23, 2006, the entire disclosure of which is hereby incorporated herein by reference, is claimed.

### BACKGROUND OF THE INVENTION

1. Field of the Technology

The invention relates to the field of communication, and more particularly to a method and a device for Generic Framing Procedure (GFP) encapsulation.

2. Field of the Invention

The GFP, No. G.7041, is a recommendation published by the International Telecommunication Union-Telecommunication Standardization Sector (ITU-T), and the Protocol Data Units (PDUs) with different length can be transferred over transport networks such as Synchronous Digital Hierarchy (SDH)/Synchronous Optical Network (SONET), Plesiochronous Digital Hierarchy (PDH) or Optical Transmission Network (OTH) through the GFP encapsulation. Through the adaptation of the GFP encapsulation, the PDUs with different types or length could be transferred in the transport networks above.

### BACKGROUND OF THE INVENTION

Because of good compatibility of the GFP, the GFP becomes a prefered encapsulation method on the Multi-service Transport Platform (MSTP), and plays an important role in the interconnecting and interworking between devices produced by different manufacturers.

An SDH network is hereinafter taken as an example to describe the mechanism of the GFP.

When a PDU needs to be transferred over the SDH network, a GFP header is added at the beginning of the PDU and a Frame Check Sequence (FCS) is added at the end of the PDU. The header information of the GFP and a format of the GFP encapsulation are shown in FIG. 1.

As shown in FIG. 1, the GFP mainly includes three parts of information.

A first part is a GFP core header with 4 bytes, including two fields; one of the two fields is a payload length indicator with 2 bytes for identifying the length of the PDU encapsulated in the GFP frame so that the PDUs varying in length may be mapped into the Virtual Container (VC) of SDH or the VC groups of SDH and that the boundary of the PDU can be defined through GFP encapsulation; the other of the two fields is a two-byte Core Header Error Check field containing a CRC-16 error control code that protects the integrity of the contents of the GFP core header by enabling both single-bit error correction and multi-bit error detection.

A second part is a GFP payload header with 4 bytes, including 5 fields described as follows:

a Payload Type Indicator (PTI) with 3 bits for identifying whether the GFP frame is a client data frame or a client management frame;

a Payload FCS Indicator (PFI) with 1 bit for identifying whether an FCS field of the GFP is added at the end of the GFP frame;

a frame header Extension Indicator (EXI) 4 bits for identifying whether the GFP frame includes an extension frame header and the type of the extension frame header;

a User Payload Indicator (UPI) with 8 bits for identifying the type of payload conveyed in the GFP Payload Information field, e.g. IP, Ethernet, Point to Point Protocol (PPP) frames, etc., in which different UPI codes identify different types of payloads;

a type Header Error Check (tHEC) containing a CRC-16 error control code that protects the integrity of the contents of a Type Field by enabling both single-bit error correction and multi-bit error detection, the Type Field includes PTI, PFI, EXI and UPI.

A third part is an FCS with 4 bytes, which is an optional field.

When a PDU is encapsulated through the GFP, the GFP header and the FCS will be added into the PDU. As shown in FIG. 2 illustrating the GFP mechanism, 8-12 bytes of the GFP header and the FCS will always be added into each PDU regardless of the length of the PDU. The GFP encapsulation efficiency can be calculated by the formula below:

$$GFP encapsulation efficiency = \frac{PDU length}{\begin{matrix}PDU length + GFP coreheaderlength + \\ GFP payload length + GFP FCSfield length\end{matrix}}$$

As can be seen from the formula, the shorter the encapsulated PDU is, the higher the ratio of the overhead of the GFP frame to the GFP frame is, and the lower the encapsulation efficiency is; and vice versa.

Therefore, it is important to increase the GFP encapsulation efficiency of a short PDU so as to achieve higher bandwidth utilization. For instance, in 3^{rd} Generation (3G) services, a voice service packet is usually a short packet with 20-40 bytes, if the voice service packet is directly encapsulated into the GFP frame with the FCS, the encapsulation efficiency is 62.5%˜76.9%.

With such encapsulation efficiency, the application of the GFP is limited in occasions such as the 3G voice service transmission. In addition, because of the low efficiency of short PDU transmission, more redundant bandwidth shall be reserved during network construction, resulting in a much higher cost of equipments.

### SUMMARY OF THE INVENTION

An embodiment of the invention provides a method for Generic Framing Procedure (GFP) encapsulation.

The method for GFP encapsulation includes cascading a plurality of protocol data units to form a cascaded packet; and encapsulating the cascaded packet to obtain a GFP frame.

Another embodiment of the invention provides a device for Generic Framing Procedure encapsulation (GFP).

The device for GFP encapsulation includes a cascading module, for cascading a plurality of protocol data units to form a cascaded packet, and a GFP encapsulation module, for encapsulating the cascaded packet to obtain a GFP frame.

According to the method and the device provided in the embodiments of the invention, the encapsulation efficiency is increased effectively, and the bandwidth utilization is increased for the GFP transmission of short PDUs.

### BRIEF DESCRIPTION OF THE DRAWINGS

FIG. 1 is a block diagram illustrating a GFP encapsulation format in the related art.

FIG. 2 is a schematic illustrating a method for GFP encapsulation in the related art.

FIG. 3 is a schematic illustrating a method for GFP encapsulation according to an embodiment of the invention.

FIG. 4 shows the structure of header information of a PDU cascaded in an embodiment of the invention.

FIG. 5 is a flowchart illustrating the process of cascading a PDU according to an embodiment of the invention,

FIG. 6 is a flowchart illustrating the process of de-cascading a cascaded packet according to an embodiment of the invention.

FIG. 7a is a flowchart illustrating the process of encapsulating a cascaded packet according to an embodiment of the invention.

FIG. 7b is a flowchart illustrating de-capsulation processing of a cascaded packet.

FIG. 8 is a flowchart illustrating another process of cascading a PDU according to an embodiment of the invention.

FIG. 9 is a flowchart illustrating another process of de-cascading a cascaded packet according to an embodiment of the invention.

FIG. 10 is a schematic illustrating a device of GFP encapsulation according to an embodiment of the invention.

FIG. 11 is a schematic illustrating an encapsulation module according to an embodiment of the invention.

FIG. 12 is another schematic illustrating a device of GFP encapsulation according to an embodiment of the invention.

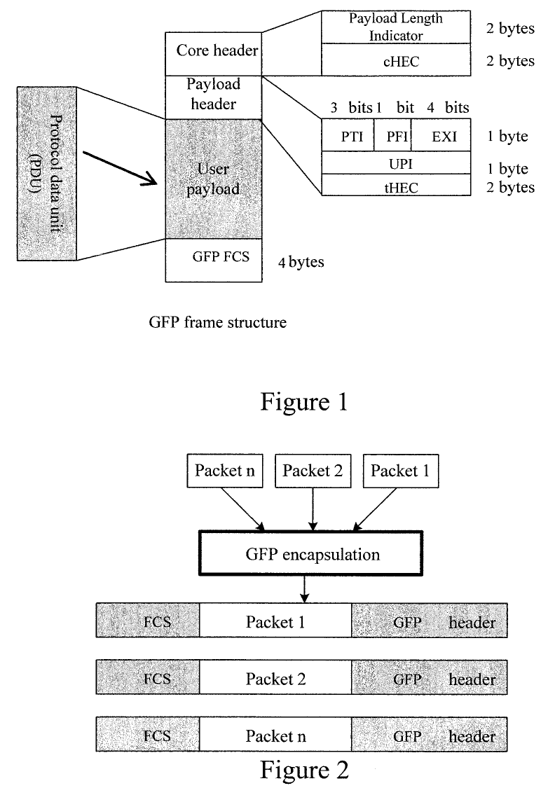

### EMBODIMENTS OF THE INVENTION

Embodiments of the invention are hereinafter described in detail with reference to the accompanying drawings.

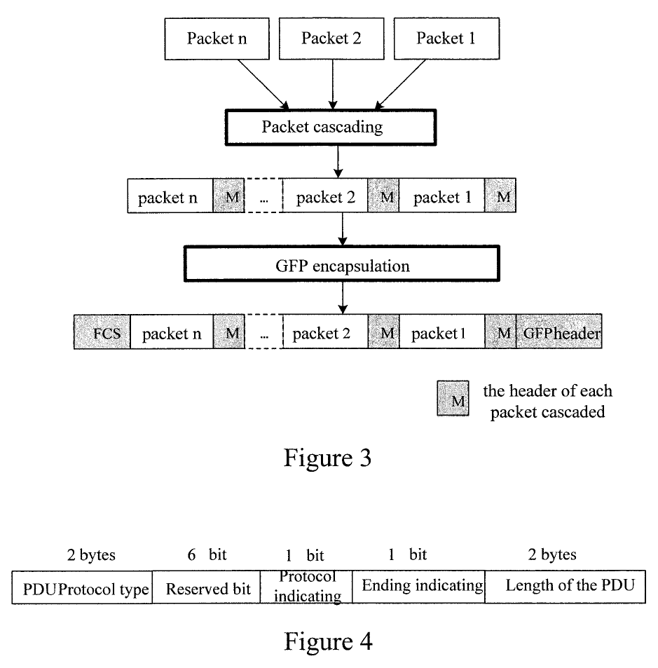

In an embodiment, a method for Generic Framing Procedure (GFP) encapsulation is provided. As shown in FIG. 3, the method includes: cascading a plurality of PDUs to form a cascaded packet and encapsulating the cascaded packet. Header information of packet cascading is added at the beginning of each PDU to be encapsulated, which has multiple bytes.

As shown in FIG. 4, the header information of the PDU cascaded includes:

a length field of a PDU for indicating, in byte, the length of the PDU corresponding to the header information of the PDU cascaded; the width of the length field may be an integral multiple of 1 byte, in this embodiment, the width of the length field is set as 2 bytes; in this way, the cascaded packet may not occupy too much overhead even if the length of the cascaded packet reaches 2¹⁶ bytes;

an ending indicating bit with 1 bit for identifying whether the PDU corresponding to the header information of the PDU cascaded is the last one in the cascaded packet, and the value of 1 indicates the end of the cascaded packet;

a protocol indicating bit with 1 bit for identifying whether the protocol type of the PDU corresponding to the header information of the PDU cascaded is consistent with that of a first PDU with a protocol indicating bit; the value of 1 indicates that the protocol type in the cascaded packet is consistent; the protocol indicating bit of header information of the first PDU cascaded in the cascaded packet may not be set as 1;

a reserved bit for future extention, which is not defined yet;

a protocol type field of the PDU for identifying the protocol type of the PDU corresponding to the header information of the PDU cascaded, which is set as 2 bytes in this embodiment, and there is no such a protocol type field while the value of the protocol indicating bit is 1.

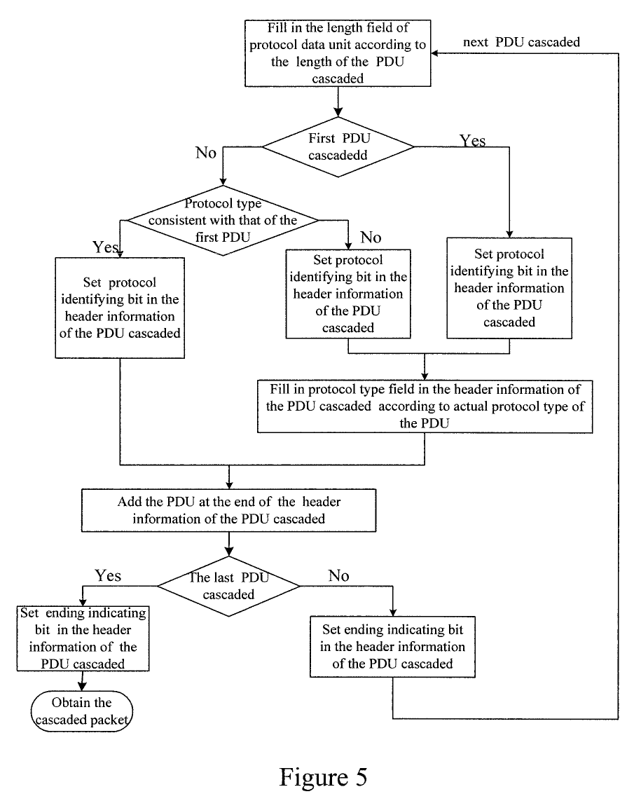

As shown in FIG. 5, the process of cascading the PDUs to be encapsulated includes:

filling the length field of the PDU according to length of the PDU;

determining whether the PDU is the first PDU to be cascaded; if yes, setting the protocol indicating bit as 0 and adding the protocol type in the protocol type field of the PDU; if no, determining whether the protocol type of the PDU is consistent with that of the first PDU; if consistent, setting the protocol indicating bit as 1; if not consistent, setting the protocol indicating bit as 0 and adding the protocol type of the PDU in the protocol type field of the PDU;

adding the PDU at the end of the header information of the PDU cascaded corresponding to the PDU, and determining whether the PDU is the last one to be cascaded; if the PDU is not the last one, setting the ending indicating bit as 0, and processing a next PDU to be cascaded according to the processes above; if the PDU is the last one, setting the ending indicating bit as 1 and terminating the process of cascading the PDUs.

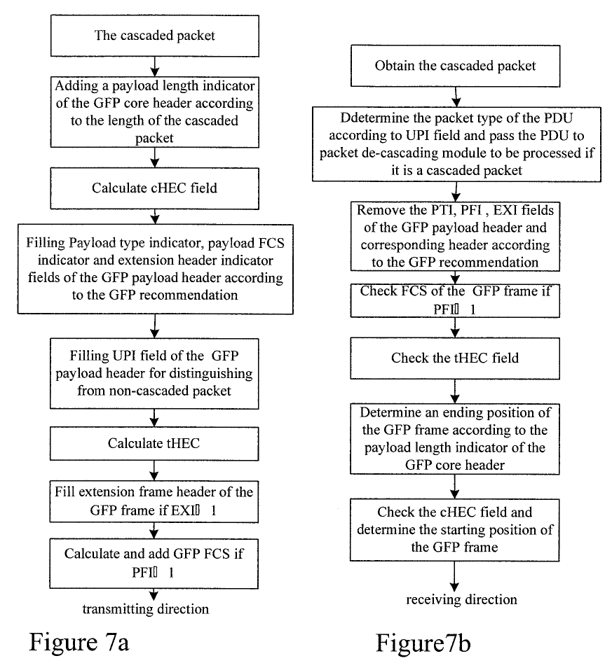

As shown in FIG. 7a, in the transmitting direction, the process of encapsulating the cascaded packet to obtain a GFP frame includes:

filling a payload length indicator field of the GFP core header according to the length of the cascaded packet, including the length of all the header information and the length of all PDUs cascaded;

calculating the core Header Error Check (cHEC) field;

filling the PTI, PFI and EXI fields of the GFP payload header according to the GFP recommendation;

filling a UPI field of the GFP payload header different from a non-cascaded packet;

calculating the tHEC;

filling an extension frame header of the GFP frame if the EXI field is non-zero; and

calculating and filling an FCS of the GFP frame if the PFI is 1.

As shown in FIG. 7b, in the receiving direction, the process of de-capsulating the GFP frame received includes:

checking the cHEC, and determining the starting position of the GFP frame;

determining the ending position of the GFP frame according to the payload length indicator field of the GFP core header;

checking the tHEC;

checking the FCS if the PFI is 1;

removing, according to the GFP recommendation, the PTI, PFI and EXI fields of the GFP payload header and the headers corresponding to the PTI, PFI and EXI fields;

determining the packet type of the PDU according to the User Payload Indicator (UPI) of the GFP payload header, and transferring the PDU to a packet de-cascading module which implements the process of de-cascading if the packet type of the PDU is a cascaded packet, i.e. splits the cascaded packet into a plurality of shorter PDUs.

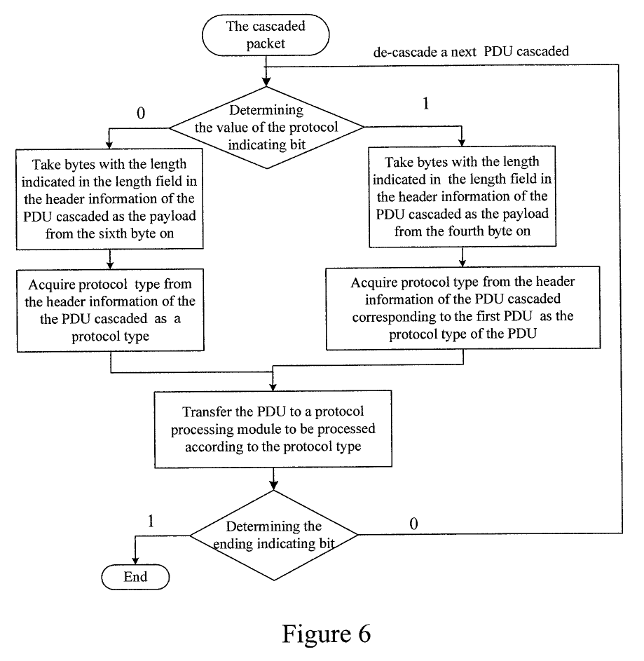

The process of de-cascading a cascaded packet for splitting the cascaded packet into a plurality of shorter PDUs is shown in FIG. 6, including:

determining the value of the protocol indicating bit in the header information of the PDU cascaded; if the value is 1, taking, from the fourth byte on, bytes corresponding to the length indicated in the length field of the PDU in the header information of the PDU cascaded as the payload of the PDU, and acquiring a protocol type from the header information of the PDU cascaded corresponding to the first PDU, which is then taken as the protocol type of the PDU; if the value is 0, taking, from the sixth byte on, the byte of which the length is indicated by the length field of the PDU in the header information of the PDU cascaded as the payload of the PDU, and acquiring a protocol type from the header information of the PDU cascaded corresponding to the PDU, which is then taken as the protocol type of the PDU;

transferring, according to the protocol type, the PDU to a protocol processing module, which processes the PDU according to a known method;

determining the value of the ending indicating bit in the header information of the packet header; de-cascading a next cascaded PDU if the value is 0, and terminating the process of de-capsulation if the value is 1.

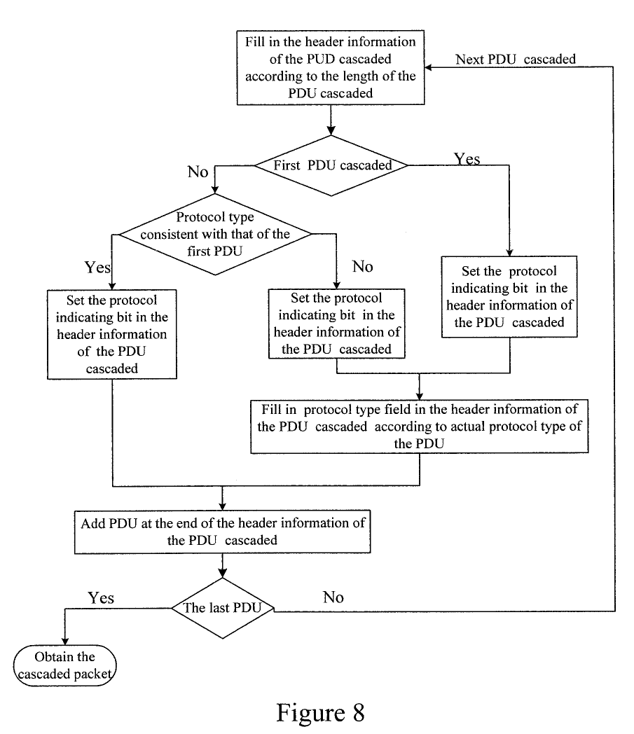

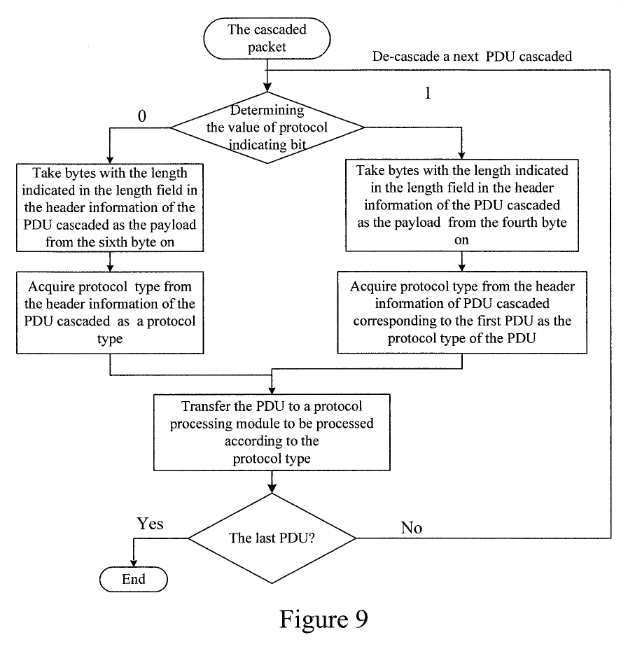

In another embodiment, what differs from the embodiment above is that there is no ending indicating bit in the header information of the PDU cascaded, and other processes are almost the same as those in the embodiment above. As shown in FIG. 8, there is not the process of setting the ending indicating bit when cascading the PDUs to be encapsulated. Accordingly, as shown in FIG. 9, during the process of de-cascading a cascaded packet for spliting the cascaded packet into a plurality of shorter PDUs, determine whether the PDU being processed is the last one instead of determining the value of the ending indicating bit in the header information of the PDU cascaded, if it is not the last one, de-cascade a next PDU cascaded, if it is the last one, terminate the process of de-cascading the cascaded packet.

Then the boundary of the cascaded packet is determined according to the framing mechanism defined in GFP recommendation.

The GFP framing mechanism means that, according to the ITU-T G.7041 definition, and based on the cHEC byte of the GFP core header, if there are 4 sequential bytes meeting the cHEC relation, the GFP state machine determines that the 4 sequential bytes are the beginning of a GFP frame and implements the ECC, and the ending position of the GFP frame can be determined by a 16-bit Payload Length Indicator (PLI) field in the GFP core header.

According to the embodiments of the invention, the bandwidth utilization is increased for the transmission of short PDUs with GFP encapsulation over the transport network. A new formula is:

$$GFP encapsulation efficiency = \frac{n \times PDU length}{\begin{matrix}n \times PDU packet length + n \times cascadeheaderlength + \\ GFP headerlength + GFP FCS length\end{matrix}}$$

In the new formula, the header information of the PDU cascaded usually has a length of 3 or 5 bytes, while the length will become more or less depending on the width of the length field of the PDU in the header information of the PDU cascaded.

When five 40-byte packets, for example, are encapsulated in a cascaded packet, the encapsulation efficiency is 84.4% as calculated by the new formula according to the embodiments of the invention versus 76.9% calculated by the formula according to the prior mechanism, that is, the encapsulation efficiency is increased by 7.5%.

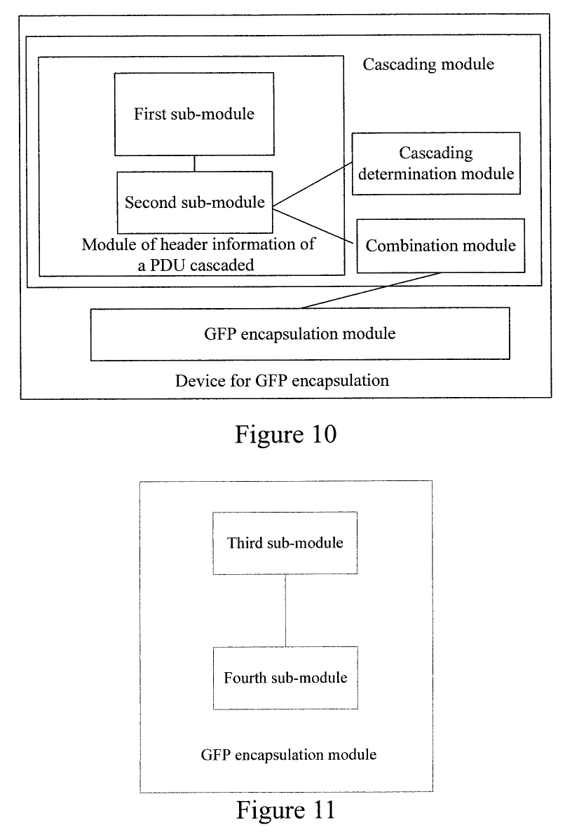

An embodiment of the invention also provides a device for GFP encapsulation. As shown in FIG. 10, the device includes a cascading module for cascading a plurality of PDUs to be encapsulated to form a cascaded packet; a GFP encapsulation module for encapsulating the cascaded packet to obtain a GFP frame.

The cascading module may include:

a module of header information of a PDU cascaded, for filling in header information of the PDU cascaded;

a combination module, for adding the header information of the PDU cascaded from the module of the header information of the PDU cascaded to the beginning of a PDU to be encapsulated; and

a cascading determination module, for determining whether the PDU is the last one to be cascaded, triggering the module of the header information of the PDU cascaded to fill in next header information of a PDU cascaded.

As shown in FIG. 10, the module of the header information of the PDU cascaded includes:

a first sub-module, for determining whether the PDU is a first PDU to be cascaded, and whether the protocol type of the PDU is consistent with that of the first PDU;

a second sub-module, for filling in a length field of the PDU, setting the protocol indicating bit according to a determination result from the first sub-module, and filling a protocol type of the PDU in a protocol type field.

Referring to FIG. 11, the GFP encapsulation module includes:

a third sub-module, for filling a payload length indicator field of the GFP core header according to the length of the cascaded packet from the combination module, and also filling a payload type indicator field, a payload FCS indicator field, an extension header indicator field of the GFP payload header, and filling an extension frame header of the GFP frame if the extension header indicator field is non-zero;

a fourth sub-module, for calculating a cHEC field and a tHEC field, setting a given value in a user payload indicator field of the GFP payload header.

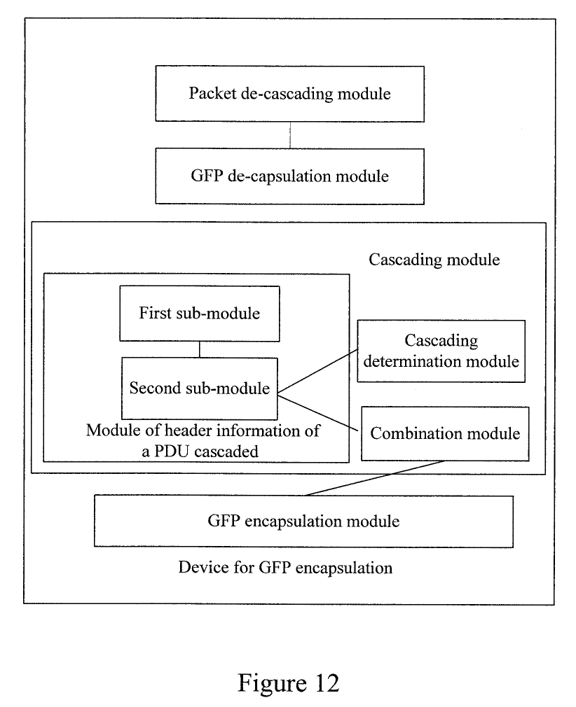

As show in FIG. 12, the device further includes:

a GFP de-capsulation module, for checking at least one of the cHEC field and the tHEC field, and the FCS of the GFP frame, determining a starting position and an ending position of the GFP frame, and the protocol type of the PDU, and removing the payload type indicator, payload FCS indicator and extension header indicator fields of the GFP payload header and corresponding header.

The above embodiments illustrate the device cascading and encapsulating the packet and transmitting the encapsulated packet outside when the packet is received. The device may also de-capsulate and decascade the cascaded packet when the cascaded packet is received.

As show in FIG. 12, the device may further include:

a packet de-cascading module, for indicating a cascaded packet from the GFP de-capsulation module, obtaining a payload and a protocol type, processing the PDU and de-cascading a next PDU cascaded.

The foregoing are only preferred embodiments of the invention but not for use in limiting the invention, those skilled in the art may make changes and variations on the basis of the invention without departing from the spirit and scope thereof. For example, in the encapsulation process above, the processing sequence of the GFP payload header is subject to appropriate adjustments depending on the actual situations and requirements. For another example, the header information of the PDU cascaded may also be longer or shorter than the prevailing value of 3 or 5 bytes depending on the width of the length field of the PDU in the header information of the PDU cascaded.

1. A method for Generic Framing Procedure (GFP) encapsulation, comprising:
cascading a plurality of protocol data units to form a cascaded packet; and
encapsulating the cascaded packet to obtain a GFP frame.

2. The method of claim 1, wherein the process of cascading a plurality of protocol data units to form a cascaded packet comprises:
filling in header information of a protocol data unit cascaded; and
adding the header information of the protocol data unit cascaded at the beginning of the protocol data unit to be cascaded.

3. The method of claim 2, wherein the header information of the protocol data unit cascaded comprises:
a length field of the protocol data unit for identifying the length of the protocol data unit corresponding to the header information of the protocol data unit cascaded;
a protocol identifying bit for identifying whether a protocol type of the protocol data unit corresponding to the header information of the protocol data unit cascaded is consistent with a protocol type of a first protocol data unit;
a protocol type field of the protocol data unit for identifying the protocol type of the protocol data unit corresponding to the header information of the protocol data unit cascaded.

4. The method of claim 3, wherein the process of filling in the header information of the protocol data unit cascaded comprises:
filling in the length field of the protocol data unit according to the length of the protocol data unit to be cascaded;
determining whether the protocol data unit is a first protocol data unit to be cascaded; if the protocol data unit is the first protocol data unit, setting the protocol identifying bit as 0 and filling the protocol type of the protocol data unit in the protocol type field of the protocol data unit;
otherwise, determining whether the protocol type of the protocol data unit is consistent with that of the first protocol data unit;
if the protocol type is consistent with that of the first protocol data unit, setting the protocol identifying bit as 1;
if not consistent, setting the protocol identifying bit as 0 and filling the protocol type of the protocol data unit in the protocol type field of the protocol data unit.

5. The method of claim 4, wherein the header information of the protocol data unit cascaded further comprises an ending identifying bit for identifying whether the protocol data unit corresponding to the header information of the protocol data unit cascaded is a last protocol data unit in the cascaded packet.

6. The method of claim 5, further comprising: setting the ending identifying bit as 0 when determining that the protocol data unit is not the last protocol data unit to be cascaded.

7. The method of claim 2, wherein the process of encapsulating the cascaded packet comprises:
filling a payload length indicator field of a GFP core header according to the length of the cascaded packet;
calculating a core Header Error Check (cHEC) field;
filling a payload type indicator field, a payload Frame Check Sequence (FCS) indicator field and an extension header indicator field of a GFP payload header according to the GFP recommendation;
setting a given value in a user payload indicator field of the GFP payload header to indicate that what to be encapsulated is a cascaded packet;
calculating a type Header Error Check (tHEC) field;
filling an extension frame header of the GFP frame if the extension header indicator field is non-zero;
calculating and filling an FCS of the GFP frame if the payload FCS indicator field is set as 1.

8. The method of claim 7, further comprising: de-capsulating the GFP frame.

9. The method of claim 8, wherein the process of de-capsulating the GFP frame comprises:
checking the cHEC field, and determining a starting position of the GFP frame;
determining an ending position of the GFP frame according to the payload length indicator field of the GFP core header;
checking the tHEC field;
removing the payload type indicator field, the payload FCS indicator field and the extension header indicator field of the GFP payload header, and checking the FCS of the GFP frame if the payload FCS indicator of the GFP payload header is set as 1;
determining a packet type of the protocol data unit according to the user payload indicator field of the GFP payload header.

10. The method of claim 9, further comprising: de-cascading the cascaded packet if the packet type of the protocol data unit is a cascaded packet.

11. The method of claim 10, wherein the process of de-cascading the cascaded packet comprises:
obtaining, according to a value of the protocol identifying bit in the header information of the protocol data unit cascaded, a payload of the protocol data unit and a protocol type of the protocol data unit;
de-cascading, when the protocol data unit is not the last one or when the value of the ending indicating bit is 0, a next protocol data unit cascaded.

12. The method of claim 11, wherein the process of obtaining the payload of the protocol data unit and the protocol type of the protocol data unit according to the value of the protocol identifying bit comprises:
when the value of protocol identifying bit is 0 which indicates that there is a protocol type field with 2 bytes following the protocol identifying bit, finding a first byte of the payload of the protocol data unit at the sixth byte from the beginning of the header information of the protocol data unit cascaded, and obtaining the payload of the protocol data unit with bytes corresponding to the length indicated in the length field of the protocol data unit in the header information of the protocol data unit cascaded, and obtaining the protocol type of the protocol data unit from the header information of the protocol data unit cascaded corresponding to the protocol data unit;
when the value of protocol identifying bit is 1 which indicates that there is no protocol type field following the protocol identifying bit, finding a first byte of the payload of the protocol data unit at the fourth byte from the beginning of the header information of the protocol data unit cascaded, and obtaining the payload of the protocol data unit with bytes corresponding to the length indicated in the length field of the protocol data unit in the header information of the protocol data unit cascaded, and obtaining the protocol type of the protocol data unit from the header information of the protocol data unit cascaded corresponding to the first protocol data unit.

13. A device for Generic Framing Procedure (GFP) encapsulation, comprising:
a cascading module for cascading a plurality of protocol data units to form a cascaded packet;
a GFP encapsulation module for encapsulating the cascaded packet to obtain a GFP frame.

14. The device of claim 13, wherein the cascading module comprises:
a module of header information of a protocol data unit cascaded, for filling in the header information of the protocol data unit cascaded;
a combination module, for adding, at the beginning of the protocol data unit to be cascaded, the header information of the protocol data unit cascaded filled by the module of the header information of the protocol data unit cascaded; and
a cascading determination unit, for determining whether the protocol data unit is the last one to be cascaded, and triggering the module of the header information of the protocol data unit cascaded to fill in next header information of a protocol data unit cascaded.

15. The device of claim 14, wherein the module of the header information of the protocol data unit cascaded comprises:
a first sub-module, for determining whether the protocol data unit is a first protocol data unit to be cascaded, and/or determining whether a protocol type of the protocol data unit is consistent with that of a first protocol data unit;
a second sub-module, for filling in a length field of the protocol data unit, setting the protocol identifying bit and filling the protocol type according to a determination result from the first sub-module.

16. The device of claim 15, wherein the GFP encapsulation module comprises:
a third sub-module, for adding a payload length indicator field of the GFP core header according to the length of the cascaded packet from the combination module, and a payload type indicator field, a payload FCS indicator field, an extension header indicator field of a GFP payload header;
a fourth sub-module, for calculating a core Header Error Check (cHEC) field and a type Header Error Check (tHEC) field, and setting a given value in a user payload indicator field of the GFP payload header.

17. The device of claim 16, further comprising:
a GFP de-capsulation module, for checking at least one of the cHEC field and the tHEC field, and the FCS of the GFP frame, determining a packet type of the protocol data unit, a starting position and an ending position of the GFP frame, and removing the payload type indicator field, the payload FCS indicator field and the extension header indicator field of the GFP payload header.

18. The device of claim 17, further comprising:
a packet de-cascading module, for identifying a cascaded packet from the GFP de-capsulation module, obtaining a payload of the protocol data unit and the protocol type of the protocol data unit, processing the protocol data unit the protocol type or de-cascading next protocol data unit.
